(19) United States
(12) Patent Application Publication
(10) Pub. No.: US 2012/0024159 A1
(43) Pub. Date: Feb. 2, 2012

(54) Coffee Preparation Device Including at Least One Preparation Material Container with a Level Indicator

(75) Inventors: Wolfgang Riessbeck, Landschlacht (CH); Hakan Sanli, Konstanz (DE)

(73) Assignee: Eugster/Frismag AG, Amriswill (CH)

(21) Appl. No.: 13/192,267

(22) Filed: Jul. 27, 2011

(30) Foreign Application Priority Data
Jul. 28, 2010 (DE) 202010010770.9-U

(51) Int. Cl. A23F 5/00

(52) U.S. Cl. 99/275

(57) ABSTRACT

In a coffee preparation device having at least one preparation material container, at least one container wall, particularly on a container front side, includes at least one filling level dependent activable luminous section as filling level indication.

The present invention relates to a coffee preparation device including at least one preparation material container which has at least one container wall, particularly on a container front wall, with a filling level indication as in accordance with the preamble of claim 1.

Highly priced coffee preparation devices are in practice increasingly provided with opto-electronic displays for operating menus and status controls of the coffee preparation device including a filling level indicator for a water container and/or coffee container of the coffee preparation device. By means of such an optoelectronic display, an instructive menu operation for handling the coffee preparation device and a visualization of information on the device inclusive of its filling level may be made. To this end, however, the technical elaboration for the optoelectronic display and the electronic components connected therewith, such as a micro controller and its programming, is relatively costly. If and when not only symbols but also text information are to be indicated on the optoelectronic displays, further complications are to be expected since in case of export, the text information should be given in the respective national language. The optical display, finally, requires careful observation from a close distance.

On the other hand, coffee preparation devices have been known in practice where an indication of the filling status is simply obtained by unchangeable marks on the water container and/or on the coffee beans container without any significant signaling effect so that they are frequently ignored.

In order to convey to the user of a drinks preparation device an information in such a way that he or she will inevitably take note of such information, a drinks preparation device has been known on the housing of which, above a base, an optical projection system has been provided by means of which a symbol or sign carrier can be projected into the direction of a drinks reception position on the base (DE 20 2007 008 590 U1). In this connection, it might be conceivable that the projection system be provided with means to exchange the projected information. The projection system is not, however, assigned to any preparation material container of the drinks preparation device nor is it provided as filling indication.

In regards to the above state of the art, it is the object of the present invention to provide, for a coffee preparation device, particularly one of simple structure, a technically non-complicated filling level indicator for the water and/or coffee container with a distinguished signaling effect which can easily be interpreted.

According to claim 1, this task is solved in principle in that at least one container wall or a container lid of the preparation material container comprises as the filling level indication at least one luminous section to be activated depending on the filling level.

By means of the filling level dependently activable luminous section, a user of the coffee preparation device is simply and distinctly visually advised that the filling level is either in order or should be corrected in that water or coffee beans, respectively, have to be refilled. By designing the filling level dependently activable luminous section as an integral part of a container wall, especially on the container front side, the association of the filling level indication to the respective preparation material container is unambiguous and cannot be misinterpreted. By means of the filling level indication in the form of the activable luminous section of the container wall, particularly on the container front side, in addition, an aesthetically particularly appealing filling level visualization can be obtained.

The at least one filling level dependently activable luminous section of the container wall which may also comprise the complete container wall, particularly on the container front side, or even the preparation material container as a whole, consists, in a first variant of the invention, of a light scattering transparent acryl glass including achromatic light scattering particles in plate shape.

If a light trapping edge of the plate-shaped container wall of light scattering transparent acryl glass is illuminated by illuminants such as LEDs; the light is normally reflected from both sides, flatly, from the plane container wall sides in the color of the trapped light.

The light scattering transparent acryl glass is commercially available under the name of PLEXIGLAS® Endlighten. A further development of the light scattering transparent acryl glass which is characterized by a reinforced sensation of brightness has been known under the mark PLEXIGLAS SATINICE®.

The filling level dependent activation of the at least one luminous section of the container wall, particularly on the container front side, may also be brought about, according to claim 2, by a filling level sensor each arranged on, or within, the preparation material container, which is provided as an optoelectronic filling level sensor or magnetic filling level sensor, or contact, or as an inductive filling level sensor or capacitive filling level sensor, and may be disposed adjacent to the one on, or within, the preparation material container.

If the filling level sensor is arranged adjacent to the stored material container in the housing of the coffee preparation device, the complete electronics connected with the filling level sensor may be disposed within the housing, without any connection to the preparation material container which is solely optically coupled with the at least one light source disposed in the housing via the light trapping edge of the container wall. For removing the preparation material container from the housing, therefore, no electric connection need by interrupted nor must it be made when applying the preparation material container to the housing. The preparation material container may be handled, particularly cleaned, without any impairment by contacts or electrical elements.

The filling level dependent activable luminous section of the container wall, particularly on the container front side may, if and when a predetermined filling level falls below a certain value, simply be activated by the filling level sensor in that by the filling level sensor at least one light source, particularly LED, is switched on the light of which is trapped by the light section, as described further below in connection with claim 3. If a plurality of filling level indications of this kind disposed one above the other on the container wall and the respective controls are provided, the position of the activated luminous section and/or the number of activated luminous sections showing the filling level may particularly well be ascertainably visualized by a person.

For filling level visualization, however, it is also possible to change the color of the at least one filling level dependent activable luminous section and to this end assign to the luminous section, provided it consists of a light conducting transparent acryl glass, a light source which is voltage dependently changeable in color, particularly a LED according to claim 11, and to feed it by a voltage, filling level dependently controlled by the filling level sensor, so that the luminous section visualizes the filling level by colors.

To the filling level “full”, the color green may for instance be assigned, to the filling level “half full”, the color yellow may for instance be assigned and to the filling level “empty”, the color red may be assigned. The at least one luminous section of the light scattering transparent acryl glass thus lights, in each case on the whole area, in the color corresponding to the filling level detected.

According to claim 3, a simple embodiment of the coffee preparation device according to the invention has the feature that the at least one container wall including the at least one luminous section consists of a light scattering transparent acryl glass, that the at least one container wall includes a light trapping edge light conductively coupled with the at least one luminous section, that at least one luminous section is coupled to the light trapping edge so that the at least one luminous section of the container wall is excited by the at least one light source to light up and that the at least one light source may be controlled by the filling level sensor.

According to claim 4, the light trapping edge may horizontally be arranged on a container wall, particularly a side wall, particularly if the side wall as a whole consists of the light scattering transparent acryl glass and thus forms a broad luminous section which is evenly lit by the light trapping edge. This container wall may, in addition, be light conductively coupled with the further walls of the preparation material container made of the same material so that by means of a row of light sources along the light trapping edge electrically connected in parallel, the preparation material container as a whole can filling level dependently be brought to lighting clearly to be seen by everyone.

In a variation according to claim 5, the container wall which is brought to even lighting by means of the light trapping edge and a plurality of light sources, is a circumferential, particularly hollow-cylindrical, container wall.

In a way reduced thereto, it is only one container wall of the light scattering transparent acryl glass, particularly the front wall of the preparation material container which, by means of a light trapping edge according to claim 6 vertically extending along the container wall can be brought to even lighting where a row of light sources are electrically connected in parallel.

According to claim 7, such an arrangement may, in detail, be further characterized in that one front side of the container wall is subdivided into luminous sections light-technologically insulated from one another, that each luminous section is light-conductively connected with one light trapping edge each, that to each of the light trapping edges at least one light source of a row of light sources is assigned such that each luminous section may be excited for lighting by the respective at least one light source, and that the at least one light source assigned to one of the light trapping edges each may filling level dependently be controlled. In particular, for a rapidly recognizable visualization of the filling level it is sufficient that, according to claim 8, the front side of the container wall is subdivided into three luminous sections light conduction technologically insulated from one another.

In the last-mentioned embodiment, the filling level is particularly clearly visualized in that, according to claim 9, the luminous sections are vertically arranged one above the other wherein the light conducting edges each of which is assigned to one of the luminous section, vertically extend on the container wall.

The filling level may particularly distinctly be visualized in that individual luminous sections of a container wall are brought to even lighting in different light colors, particularly as in accordance with claim 12, according to which the light sources of the luminous sections, i.e. the light sources from which light is coupled into one of the luminous sections each, are LEDs the light colors of which, independently from each other, are voltage dependently fixed and which are filling level dependently activated, i.e. switched on.

In each of the foregoing cases, the at least one light source is advantageously solidly secured, according to claim 10, to the coffee preparation device in order to keep the preparation material container clear of the light source and the voltage feeder line thereof.

Even if the filling level dependently activable luminous sections of the filling level indicator according to the invention do not necessarily require any text information for filling level visualization and the understanding thereof, the luminous sections may, according to claim 13, optionally constitute additional carriers of characters or symbol information in order to explain the visualization and/or to request action, particularly for refilling the assigned preparation material container.

Although the filling level visualization according to the invention is well noticeable, particular filling levels, especially an emptying of the preparation material container, may additionally be emphasized, according to claim 14, by a filling level dependent flickering activation of the luminous section to which end a control of the voltage of the at least one light source light conductively coupled with the luminous section via a light trapping edge is provided.

In a second variant of the embodiment of the invention of the at least one luminous section on the at least one container wall, the latter is formed, according to claim 15, as a thin-film light emitting diode made of an organic semiconductive material which is loaded with a voltage respectively controlled by the filling level sensor of the coffee preparation device. The organic semi-conductive material is also referred to as an organic light emitting diode, abbreviated as OLED. The OLEDs may contain colorants, the color of the light emitted upon electric excitation of the OLEDs depending on the kind of the colorant molecules. The OLED may economically be applied onto the surface of the filling level dependent activable luminous section of the container wall by coating or by imprinting. The OLED faces may, on principle, be arranged analogously relative to the luminous section of a light scattering transparent acryl glass as in accordance with the first variant.

The advantage of such formation of the at least one luminous section on at least one container wall is seen in that no light source for the excitation of the OLED is necessary, it can rather directly be excited by applying a voltage. To this end, the voltage should be applied to the preparation material container with the OLED via contacts from the coffee preparation device.

By electrical control of an OLED face, or a luminous section, the color of the emitted light may be changed. The OLED face is activated by the filling level sensor as in accordance with claim 2.

The filling level is visualized with OLEDs particularly manifest by an arrangement according to claim 16 according to which the front side of the preparation material container comprises three OLED faces disposed one above the other and staggered relative to each other and electrically insulated relative to each other. In this connection, according to claim 19, an uppermost OLED face may be activated, i.e. excited to light, by a filling level sensor which senses a full preparation material container, a middle OLED face may be activated by a filling level sensor sensing a half full preparation material container, and a lower one of the OLED faces may be activated by a filling level sensor sensing the empty state of the preparation material container.

The supply of the voltage controlled by one filling level sensor each to the respective OLED face is realized, according to claim 17, via at least one contact each disposed on the preparation material container contactable with one current supply contact each solidly provided on the device, wherein on the respective one of the current supply contacts a voltage is applied which is controlled by the filling level sensor assigned.

According to claim 18, the contacts arranged on the preparation material container may, extensively protected, be compactly integrated within a multi-point connector to be slid on the current supply contacts solidly provided on the device.

Instead of simple OLED faces which only as such form filling level dependent activable luminous sections to visualize the filling level of a preparation material container, one luminous section may be provided, according to claim 20, as an OLED face with a scale which can be excited controlled by at least one filling level sensor. By means of the filling level dependent luminescent scale, the filling level may be indicated exact and noticeable.

In a third variant of the filling level dependently activable luminous section as filling level indication on a container wall of a water container, this luminous section may be made, according to claim 21, particularly uncomplicatedly.

Accordingly, at least one wall, for instance a front wall, of the water container consists of a transparent material the refractive index of which is greater than the one of air, for instance of common transparent acryl glass. To a light trapping edge on the wall, there is assigned a light source which is luminous independently of the filling level. From an inner side of the wall, a scale is formed out so that a section of the scale not wetted by water is luminous and a section wetted by water is not luminous. The scale may be considered as a variable luminous section.

This variant of the filling level visualization does not require any filling level dependent control of at least one light source or of an OLED face and is, therefore, particularly little elaborate and function-proof. The function is based on the fact that the refractive index of the water deviates significantly from the one of air, similar to the refractive index of the transparent material of the wall. The consequence is that the scale formed out from the inner side of the wall is not luminous if covered by water, the scale portion exposed to the air, however, is luminous caused by the light irradiated into the light trapping edge. In this way, a sensitive filling level indication may be realized which is particularly striking if colored light of the light source is fed into the light trapping edge.

The transparent material, or the plastic material, from which the wall of the water container of the present variant is made may be interspersed with fluorescent particles. This will cause that the whole wall of the water container will be luminous, though not in that measure as the scale formed out from the material as optical irregularity, providing that no water is bordering it.

The afore-described advantageous effects may in principle also be obtained, according to claim 22, in that at least one light source is assigned to at least one light trapping lens on a water container as preparation material container, and that at least one luminous section of the water container is so formed or provided with a coating that a section of the water container not wetted by water and a section of the water container wetted by water appear as having differently intense luminescence. In this connection, the luminous section, or the respective zone of the container, constitutes an optical irregularity from which light entrapped in the container exits with a different intensity relative to an ambient adjoining the irregularity.

In general, the preparation material container may also be a coffee beans container of the coffee preparation device. In this case, the first variant and the second variant of the filling level visualization may be applied as in case of a water container; the third variant cannot, however, be applied since it requires water as the preparation substance.

For the filling level visualization of the filling of a coffee beans container, the embodiment according to claim 5 may particularly be suited according to which the coffee beans container has a circumferential container wall which is excited via the light trapping edge by at least one light source to be luminous if the at least one light source, controlled by the filling level sensor, is activated when the coffee beans container is empty.

In accordance with a fourth variant of the filling level visualization of the invention, the tank of the coffee preparation device includes, according to claim 23, a window in a tank wall in front of a transparent preparation material container integrated in the tank, and on one front side of the tank wall, at least along one section of the window, a light string is arranged as a filling level dependent activable luminous section in parallel to a contour of the preparation material container in a front view. The filling level dependent activation of the luminous section is initiated by a filling level sensor which is preferably disposed either neighboring the preparation material container or at, or within, the preparation material container. By the light string luminous in case of a low filling level or empty preparation material container, the filling level visualized thereby will significantly be related to the transparent preparation material container visible behind the tank wall.

According to claim 24, this light string on the front side of the tank wall may be supplemented by a light string in the lid of the tank above the preparation material container, the light string being disposed in parallel to a contour of the preparation material container in a top view. A further light string may be disposed, according to claim 25, in parallel to the contour of the preparation material container in a view on the bottom which can be observed through the window in the front side of the tank wall. As a whole, the spatial contour of the preparation material container may be highlighted by the light strings, and it can be made clear that the preparation material container should be refilled.

In connection with this variant of the filling level visualization of the preparation material container, a transparent water container is preferred by which the light string disposed on the bottom of the tank is not concealed.

The at least one light string may be an electro luminescence string according to claim 26 activated by a filling level sensor controlled voltage.

Alternatively, the light string may be made, according to claim 27, as a light conductor with coupling-in of a neighboring LED which may filling level dependently be activated, i.e. switched on.

According to claim 28, moreover, the light string may be made in the form of a chain-like series of LEDs which are also filling level dependently activated.

According to claim 29, the light string is suitably disposed within a groove provided in the tank wall, or of the lid or of the bottom of the tank, where it is readily visible yet is extensively protected against damages.

In a still further variant of the filling level visualization according to claim 30, the lid of the tank may include a transparent section as a luminous section and in a bottom of the tank a filling level dependently controlled LED may be arranged directed to the transparent section of the lid. In case of a low filling level, or of an empty preparation material container, the filling level dependently controlled LED radiates from the bottom through the tank from below onto the transparent section of the lid which will light up, and visualizes in this way the empty preparation material container. The visualization may be supplemented by a text in the transparent section.

In a still further variant of the filling level visualization according to claim 31, a tank of the coffee preparation device includes a window in a tank wall in front of the transparent preparation material container integrated in the tank, and on a front side of the tank wall a light source is disposed by which a base of the coffee preparation device in front of the tank wall may filling level dependently illuminated in order to particularly visualize distinctly an empty state of the preparation material container.

According to claim 32, the preparation material container may at the same time be filling level dependently illuminated by the light source in the tank wall as well which makes the allocation of the information on the base to the preparation material container easier.

In this variant, the light source may be provided as a LED arrangement or as a fluorescence lamp.

This filling level visualization has the advantage of a good recognition from the front and of an extensive independence of the transparency of the tank interior.

Embodiments of the first, second and third variants of the invention will be described in the following based on a drawing showing six figures from which further advantageous details may result. With reference to an espresso machine and in a simplified diagrammatic illustration,

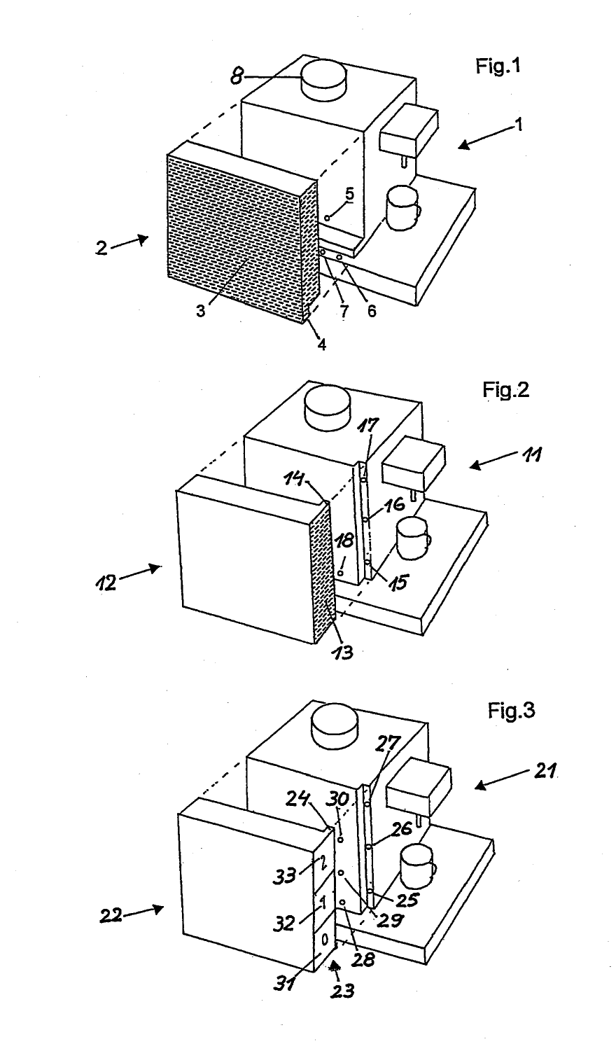

FIG. 1 shows a first embodiment of the first variant of the invention,

FIG. 2 shows a second embodiment of the first variant of the invention,

FIG. 3 shows a third embodiment of the first variant of the invention,

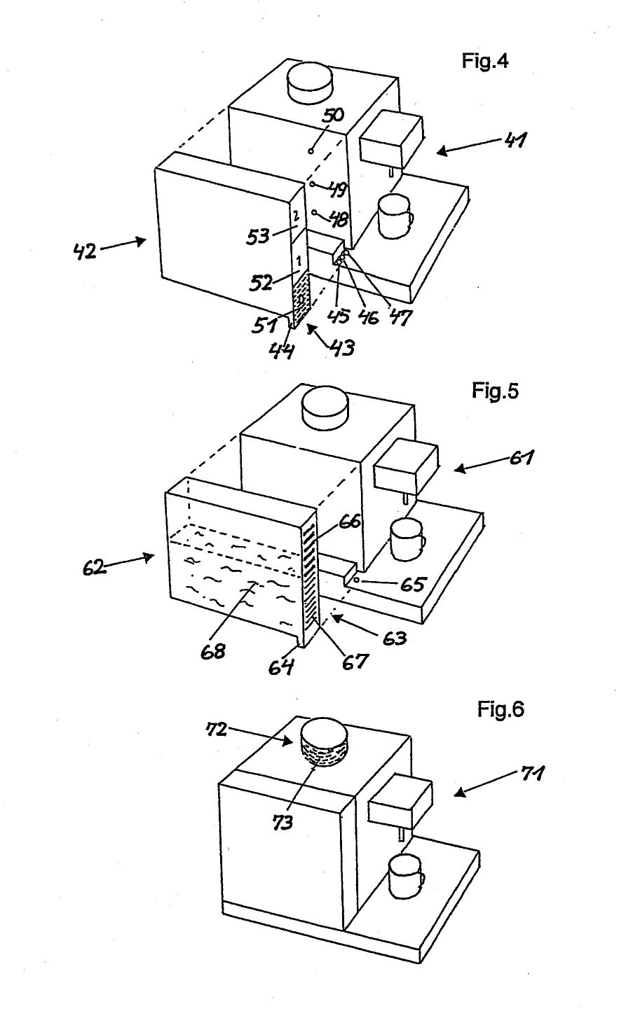

FIG. 4 shows an embodiment of the second variant of the invention,

FIG. 5 shows a third variant of the invention and

FIG. 6 shows a further embodiment of the first variant of the invention.

In the embodiments according to FIGS. 1 to 5, a water container each 2, 12, 22, 42, 62 of the espresso machine 1, 11, 21,41, 61 is shown for better illustration detached from it. In the embodiment according to FIG. 6, the water container having no reference numeral is attached to the espresso machine 71.

According to FIG. 1, a water container 2 is associated to an espresso machine 1 which water container 2 can be attached to the espresso machine 1 like the not-designated water container of FIG. 6. It consists of a light scattering transparent acryl glass.

One of two side faces facing each other of the water container 1, is designated as 3. From the side face 3, a light trapping edge 4 is formed out which, in the attached state of the water container 2, faces two parallel-connected light sources 6, 7 disposed on the side of the espresso machine facing the water container 2 so that the light emitted by the light sources 6, 7 is entrapped by the light trapping edge 4 when the water container is attached to the espresso machine.

For filling level dependent control of the light sources 6, 7, a filling level sensor 5 is disposed in the side of the espresso machine 1 facing the water container 2.

The arrangement of the filling level sensor 5 and of the electric circuit connected therewith via which the light sources 6, 7 are controlled by the filling level sensor 5 is so designed that the light sources 6, 7 light up activated by the filling level sensor when the filling level of the water in the water container is below a predetermined minimum, particularly when the water container has been emptied.

In this state of the water container 1, the side face 3 and the remaining faces of the water container 2 light-conductively connected with face 3 will light up through the light from the light sources 6, 7 entrapped in the light trapping edge 4. In FIG. 1, the water container 2 is shown in a luminous state even if it is detached from the espresso machine 1.

In FIG. 1, a coffee beans container 8 is depicted as well. A filling level dependent or coffee beans filling level dependent visualization will be described later in connection with FIG. 6 wherein the coffee beans container is designated as 72.

In the second embodiment according to FIG. 2, both the espresso machine 11 and the water container 12 are modified.

In this embodiment, a front wall 13 at which, vertically on one side, a light trapping edge 14 is provided, consists of light scattering transparent acryl glass.

For entrapping the light in the light trapping edge 14, three light sources 15, 16, 17 disposed in a vertical row and electrically connected in parallel are provided on the side of the espresso machine 11 facing the water container 12. A filling level sensor 18 is disposed, as in the embodiment according to FIG. 1, on the side of the espresso machine 11 facing the water container 12 in order to filling level dependently control the light sources 15, 16, 17 and to make the front wall 13 luminous by the entrapped light from the light sources 15, 16, 17 when the filling level sensed by the filling level sensor falls below a predetermined value. It is for this case that the front wall 13 in FIG. 2 is depicted as a luminous face.

While in the second embodiment according to FIG. 2 the light sources 15, 16, 17 are electrically connected in parallel and for the common activation of the illuminant front wall 13 need be controlled by only one filling level sensor 18, the third embodiment according to FIG. 3 differs from it in that to the light sources 25, 26, 27 vertically disposed in one row, as in FIG. 2, one filling level sensor 28, 29, 30 each is assigned, wherein the filling level sensors 28, 29, 30 are also disposed one above the other on a side of the espresso machine 21 facing a water container 22.

A further difference consists in that the front wall 23 of the water container 22 is divided in three luminous sections 31, 32, 33, arranged one above the other, which are light conduction technologically insulated from each other. From each of the luminous sections, an individual light trapping edge is formed out each of which being separated from the other light trapping edges. In FIG. 3, only the light trapping edge 24 is visible.

The filling level sensors 28, 29, 30, the light sources 25, 26, 27 and the light trapping edges, particularly 24, are so assigned to the luminous sections 31, 32, 33 that the luminous section 33 lights up when the sensor 30 senses a full water container, the luminous section 32 is activated to light up when the filling level sensor 29 senses a half full water container 22 and the luminous section 31 is activated to light up when the filling level sensor 28 senses an empty water container 22.

As shown, the luminous sections 31, 32, 33 may additionally be provided with numerals referring to the filling levels mentioned of the water container 22.

The embodiment of the second variant of the filling level visualization according to FIG. 4 in which an espresso machine is designated with 41 and a water container with 42, shows an arrangement of luminous sections 41, 52, 53 similar to the one of the luminous sections 31, 32, 33 in FIG. 3 wherein, however, the luminous sections 51, 52, 53 are three OLED faces electrically insulated from each other which are applied as thin-film light emitting diodes on the front wall 43 of the water container 42.

The luminous sections 51, 52, 53 are contacted via a connector 44 with current supply contacts 45, 46, 47 when the water container 42 is attached to the espresso machine 41. The current, or the voltage at the current supply contacts 45, 46, 47, is controlled by filling level sensors 48, 49, 50 individually assigned to the current supply sensors 45, 46 47, namely with respect to the filling level in the water container 42 sensed by the filling level sensors 48, 49, 50.

This means that the luminous section 53 is activated by the filling level sensor 50, i.e. is made luminous by the current controlled by the filling level sensor 50 in case of a full water container 42, via the current supply contact 47. The luminous section 52 is made to be luminous by the filling level sensor 49 which senses a half full water container 42, via the current supply contact 46. Or, the luminous section 51 is activated, i.e. made to be luminous, by the filling level sensor 48 which senses an empty water container 42, via the current supply contact 45. In the situation depicted in FIG. 4, the last-mentioned luminous section is lighted. In this case, too, the luminous sections 51, 52, 53 may show alphanumerical symbols for an additional indication of the visualized filling levels.

The espresso machine 51 with a respective water container 62 diagrammatically shown in FIG. 5 constitutes an embodiment of a third variant of the filling level visualization of the water container which can get along with one sole filling level independent light source 65 which, therefore, can constantly be luminous once the espressos machine has been switched on. For filling level visualization, the front wall 63 has a light trapping edge 64 which, in the assembled state of water container 62 and espresso machine 61, guides the light radiated from the light source 65 into the front wall 63 so that the front wall 63 is constantly completely illuminated. On the inner side of the front wall 63, a scale 66 is formed out of it in a way that the scale section 67 covered by the water 68, i.e. the formed-out marks of this scale section, do not light up or light up as an emphasis. A luminous emphasis, on the other hand, is constituted by the marks of the scale section not covered by water, as shown in FIG. 5. This is based on the fact that the power of refraction of air at this scale section is significantly smaller that the one of the material from which the front wall 63 is made, whereas the water has a similar power of refraction. This filling level visualization does not, therefore, require any electrical control which is controlled dependent of a filling level sensor.

While the embodiments according to FIGS. 1 to 5 realize a filling level visualization of the water container, the embodiment according to FIG. 6 which refers to the first variant of the filling level visualization shows a filling level visualization of the coffee beans container designated by 72 in the diagrammatically shown espresso machine 71.

The coffee beans container 72 of this espresso machine 71 is designed as a hollow cylinder of a light scattering transparent acryl glass the circumferential wall 73 of which may be illuminated by light sources disposed in the espresso machine 71. The light of these light sources can be entrapped via a light trapping edge, not shown, for instance on the lower front side of the circumferential wall 73. The parallel-connected light sources may be controlled by only one filling level sensor which senses an empty state of the coffee beans container 72 in order to activate, or switch on, a voltage loading the light sources. The kind of filling level sensor is adapted to the properties of the preparation material monitored, in the present case the coffee beans.

1. Coffee preparation device including at least one preparation material container (2, 8, 12, 22, 42, 62, 72) which has at least one container wall (3, 13, 23, 43, 63, 73) particularly on a container front wall, with a filling level indication,
characterized in
that the at least one container wall (3, 13, 23, 43, 63, 73) or a container lid includes at least one filling level .dependent activable luminous section (31, 32, 33; 51, 52, 53) as filling level indication.

2. Coffee preparation device according to claim 1,
characterized in
that the at least one luminous section (31, 32, 33;, 51, 52, 53) may be activated by a filling level sensor (5; 18; 28, 29, 30; 48, 49, 50) each arranged adjacent to, on, or in, the preparation material container (2, 12, 22, 42, 62).

3. Coffee preparation device according to claim 2,
characterized in
that the at least one container wall (3, 13, 23, 43, 73) with the at least one luminous section (31, 32, 33; 51, 52, 53) consists of a light scattering transparent acryl glass,
that the at least one container wall (3, 13, 23, 43, 73) has a light trapping edge (4, 14, 24) light conductively coupled with the at least one luminous section (31, 32, 33; 51, 52, 53),
that at least one light source (6, 7;, 15, 16, 17; 25, 26, 27) is assigned to the light trapping edge (4, 14, 24) so that the at least one luminous section (31, 32, 33;, 51, 52, 53) of the container wall (3, 13, 23, 43, 73) may be excited to be luminous and
that the at least one light source (6, 7; 15, 16, 17; 25, 26, 27) may be controlled by the filling level sensor (5; 18; 28, 30; 48, 49, 50).

4. Coffee preparation device according to claim 3,
characterized in
that the light trapping edge (4) extends horizontally on the container wall (3) and
that a row of light sources (6, 7) is arranged along the light trapping edge and is electrically connected in parallel.

5. Coffee preparation device according to claim 3 or 4,
characterized in
that the preparation material container (8, 72) has a circumferential container wall (73) which may be excited to be luminous by the at least one light source via the light trapping edge when the at least one light source is activated controlled by the filling level sensor when the preparation material container is empty.

6. Coffee preparation device according to claim 3,
characterized in
that the light trapping edge (14) extends vertically on the container wall (13) and
that a row of light sources (15, 16, 17) is electrically connected in parallel.

7. Coffee preparation device according to claim 3
characterized in
that a front side of the container wall (23) is subdivided into luminous sections (31, 32, 33) light conduction technologically insulated from one another,
that each luminous section (31, 32, 33) is in light-conductive connection with one light trapping edge each (for instance 24),
that at least one light source (25, 26, 27) of a row of light sources is assigned to each of the light trapping edges (for instance 24) so that each luminous section (31, 32, 33) can be excited to be luminous by the respective at least one light source (25, 26, 27) and
that the at least one light source (25, 26, 27) which is assigned to one of the light trapping edges each (for instance 24) may individually be filling level dependently controlled.

8. Coffee preparation device according to claim 7,
characterized in
that the front side of the container wall (23) is divided into three luminous sections (31, 32, 33) which are light conduction technologically insulated from one another.

9. Coffee preparation device according to claim 7 or 8,
characterized in
that the luminous sections (31, 32, 33) are disposed vertically one above the other and
that the light conductive edges (for instance 24) extend vertically on the container wall.

10. Coffee preparation device according to one of claims 3 to 9,
characterized in
that the at least one light source (6, 7; 15, 16, 17; 25, 26, 27) is solidly secured to the coffee preparation device 2, 12, 22).

11. Coffee preparation device according to one of claims 3 to 10,
characterized in
that the at least one light source (6, 7; 15, 16, 17; 25, 26, 27) is a LED the light color of which is voltage dependently changeable wherein the voltage may filling level dependently controlled.

12. Coffee preparation device according to one of claims 7 to 10,
characterized in
that the light sources (25, 26, 27) of the filling level dependently activable luminous sections (31, 32, 33) are LEDs the different light colors of which are fixedly set and which may filling level dependently be switched on.

13. Coffee preparation device according to one of the foregoing claims,
characterized in
that the luminous sections (31, 32, 33) are carriers of characters or symbol information.

14. Coffee preparation device according to one of the foregoing claims
characterized by
a filling level dependent control of the at least one light source (6, 7; 15, 16, 17; 25, 26, 27) or the at least one luminous section so that it is flickering.

15. Coffee preparation device according to claim 2,
characterized in
that the at least one luminous section (51, 52, 53) on the at least one container wall (43) is made as a thin-film light emitting diode of an organic semiconductive material (OLED) and is loaded with a respective voltage controlled by the filling level sensor (48, 49, 50).

16. Coffee preparation device according to claim 15,
characterized in
that the front side of the preparation material container (42) comprises three OLED faces (51, 52, 53) disposed one above the other and staggered relative to each other and electrically insulated relative to each other.

17. Coffee preparation device according to claim 15 or 16,
characterized in
that each of the OLED faces (51, 52, 53) are connected with at least one contact arranged on the preparation material container, which contact may be connected with one current supply contact each (45, 46, 47) provided on the device and
that on each of the current supply contacts (45, 46,47) a voltage is applied which is filling level dependently controlled by the filling level sensor (48, 49, 50) assigned.

18. Coffee preparation device according to claim 17,
characterized in
that the contacts arranged on the preparation material container (42) are arranged in a contactor (44) which may be slid onto the current supply contacts (45, 46, 47).

19. Coffee preparation device according to claims 16 to 18,
characterized in
that the voltage at one of the OLED faces each (51, 52, 53) is controlled by a filling level sensor (48, 49, 59) each assigned to the OLED face,
that thereby an uppermost OLED face (53) may be activated by the filling level sensor (50) which senses a full state of the preparation material container (42), a middle OLED face (52) may be activated by the filling level (49) which senses a half full state of the preparation material container (42) and a lower OLED face (51) may be activated by the filling level sensor (48) which senses an empty state of the preparation material container (42).

20. Coffee preparation device according to claim 15,
characterized in
that the at least one luminous section is made as an OLED face with a scale which, controlled by at least one filling level sensor, may be activated in analogy to the filling state.

21. Coffee preparation device according to claim 1,
characterized in
that the preparation material container is a water container (62), that at least one wall (for instance 63) of the water container (62) consists of a transparent material the refractive index of which is greater than that of air,
that at least one light source (65) is assigned to a light trapping edge (34) on the wall (for instance 63) and
that from an inner side of the wall (for instance (63) a scale (66) is formed out as the at least one luminous section in such a way that a section of the scale not wetted by water is luminous and a scale section (67) wetted by water is not luminous.

22. Coffee preparation device according to claim 1,
characterized in
that at least one light source is assigned to at least one light trapping lens on a water container as preparation material container and that at least one luminous section of the water container is so formed out or provided with a cover that a section of the water container not wetted by water and a section of the water container wetted by water appear luminous with distinguishing intensity.

23. Coffee preparation device according to claim 2,
characterized in
that a tank of the coffee preparation device includes a window in a tank wall in front of the transparent preparation material container integrated in the tank and that on a front side of the tank wall, at least along a section of the window, a light string is arranged as a luminous section parallel to the contour of the preparation material container in a front view.

24. Coffee preparation device according to claim 23,
characterized in
that a lid of the tank above the preparation material container has at least one light string which is disposed in parallel to a contour of the preparation material container in a top view of the preparation material container.

25. Coffee preparation device according to claim 23 or 24,
characterized in
that in the interior of the tank behind the window at least one light string is disposed on a bottom of the tank in parallel to a contour of the preparation material container in a view to the bottom thereof.

26. Coffee preparation device according to one of claims 23 to 25,
characterized in
that the at least one light string is an electroluminescence string.

27. Coffee preparation device according to one of claims 23 to 25,
characterized in
that the light string is a light conductor with coupling-in of a LED neighboring a light trapping face of the light conductor, wherein the LED may filling level dependently be activated.

28. Coffee preparation device according to one of claims 23 to 25
characterized in
that the light string is a chain-like row of LEDs which may filling level dependently be activated.

29. Coffee preparation device according to one of claims 23 to 28,
characterized in
that the light string is arranged in a groove of the tank wall or the lid, or the bottom of the tank.

30. Coffee preparation device according to claim 2,
characterized in
that the lid of the tank includes at least one transparent section as luminous section and
that in a bottom of the tank a filling level dependently controlled LED is arranged which is directed to the transparent section of the lid.

31. Coffee preparation device according to claim 2,
characterized in
that a tank of the coffee preparation device includes a window in a tank wall in front of the transparent preparation material container integrated in the tank and
that on a front side of the tank wall a light source is arranged by means of which a base of the coffee preparation device in front of the tank wall can be illuminated.

32. Coffee preparation device according to claim 31,
characterized in
that by means of the light source in the tank wall, the preparation material container can be illuminated as well.

33. Coffee preparation device according to one of claims 1 to 20, 23 to 32,
characterized in
that the preparation material container is a water container (2, 12, 22, 42, 62).

34. Coffee preparation device according to one of claims 1 to 19, 23-29, 31, 32,
characterized in
that the preparation material container is a coffee beans container (18, 72).
